(19) United States
(12) Patent Application Publication
(10) Pub. No.: US 2003/0155823 A1
(43) Pub. Date: Aug. 21, 2003

(54) Motion absorber

(76) Inventor: Wilfried Willner, Augsburg (DE)

Correspondence Address: Flynn Thiel, Boutell & Tanis, 2026 Rambling Road, Kalamazoo, MI, 49008-1699, US

(21) Appl. No.: 10/333,197

(22) PCT Filed: Jul. 14, 2001
(86) PCT No.: PCT/EP01/08138

(51) Int. Cl. H02K 5/24

(52) U.S. Cl. 310/51

(57) ABSTRACT

The invention relates to a motion absorber comprising a housing (1), a connecting member (2) that is mounted to be movable with respect to the housing and that is linked with a movable part whose motion should be absorbed, and an absorber element that absorbs the motion of the connecting member (2) in the housing (1). Conventional motion absorbers are disadvantageous in that their operability is limited at wide temperature variations. The aim of the invention is therefor to provide a motion absorber whose absorbing effect is as independent of the ambient temperature as possible. To this end, the absorber element is a two-part structure and comprises a permanent magnet (3) and an opposite pole (4). One part is arranged on the housing (1) and the other part is arranged on the connecting member. The magnetic force acting between the permanent magnet (3) and the antipole (4) absorbs the motion of the connecting member (2) in the housing (1).

The invention relates to a motion absorber according to the preamble of claim 1.

Such motion absorbers are used, for example, in the automotive industry to absorb the movement of mobile structural parts, as, for example, rear hatches, glove-compartment doors or drawer-like cup-holders, ashtrays or the like.

In order to avoid abrupt opening or closing movements, it is desirable to absorb the movement of the structural parts. Glove-compartment doors, for example, are designed such that they tilt into the open position during unlocking under the action of gravity. In order for the glove-compartment door not to suddenly tilt down and fall onto the legs of the passenger, the motion absorber is supposed to cause a slowing down of the opening movement of the glove-compartment door. In reverse, however, it is desirable that the motion absorber does, as much as possible, not put forth any resistance during a closing of the door.

Pneumatic absorbers or viscous absorbers are known for these purposes from the state of the art. They have a housing in which is arranged a connecting member movably supported with respect to the housing. The connecting member is connected at one end to the part, for example, the swingable door, the motion of which is to be absorbed. The movement of the connecting member is absorbed within the housing by an absorber element. The absorber element has in the case of viscous absorbers an impeller wheel which moves in a viscous bath. The damping of the impeller wheel occurs through the inner friction between the impeller wheel and the viscous liquid.

Viscous absorbers have the disadvantage that the absorption of the movement of the connecting member depends very much on the temperature because of the temperature dependency of the viscosity of the absorbing liquid. This has the result that at very high temperatures, which occur often in a motor vehicle in particular in the summer, the absorbing action is much reduced. Furthermore, it can happen that at very high temperatures liquid will leak from the housing.

The purpose of the present invention is therefore to make available a motion absorber of the above-mentioned type in which the absorbing action depends as little as possible from the surrounding temperature.

This purpose is attained with the characterizing characteristics of claim 1. Advantageous exemplary embodiments can be taken from the subclaims.

The invention will be discussed in greater detail hereinafter in connection with the exemplary embodiments and with reference to the accompanying drawings, in which:

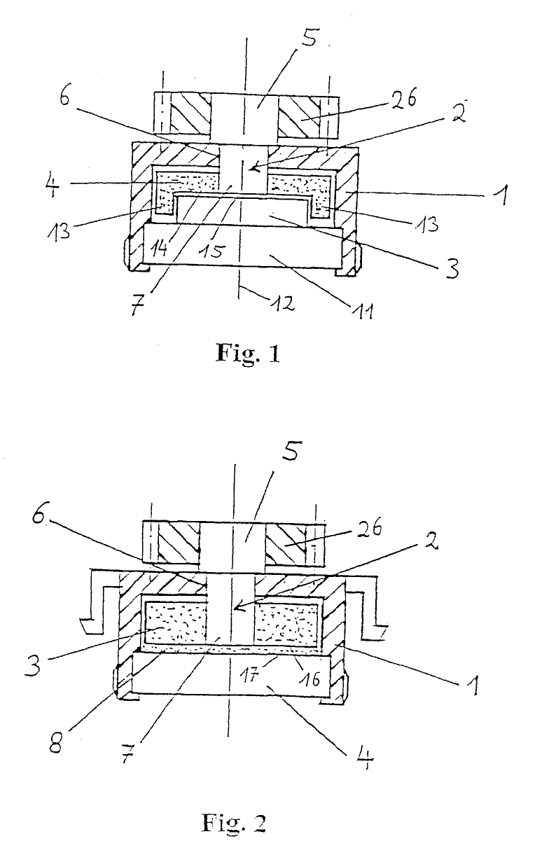

FIG. 1: A cross-sectional view of a first preferred embodiment of an inventive motion absorber, which is designed as a rotation absorber;

FIG. 2: A cross-sectional view of a preferred embodiment of the motion absorber of FIG. 1;

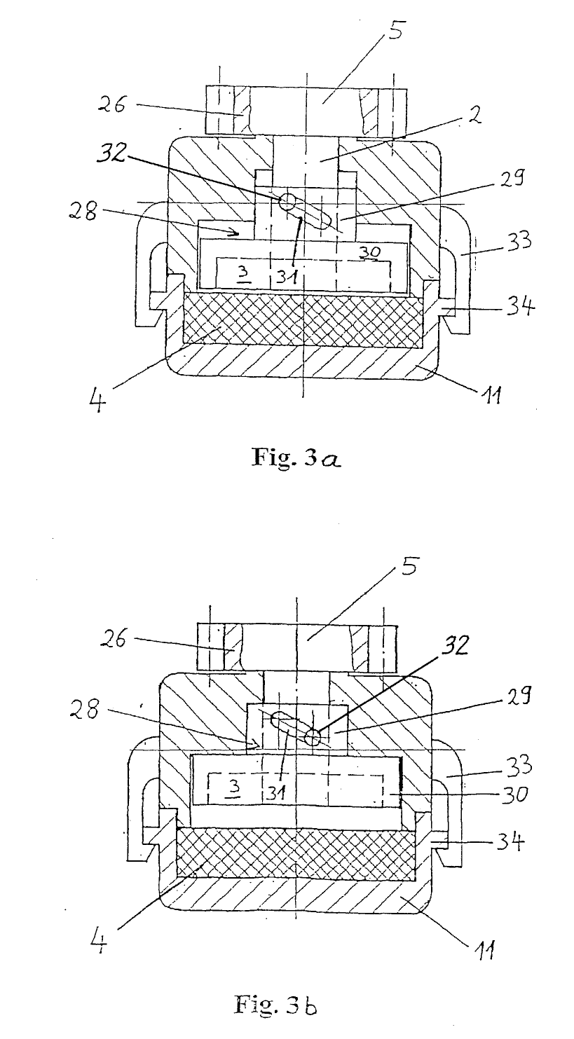

FIG. 3: A cross-sectional view of a further preferred embodiment of the motion absorber of FIG. 1;

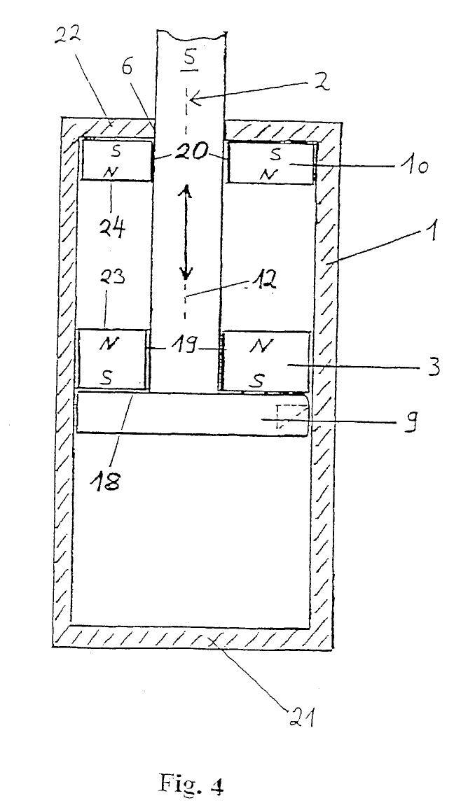

FIG. 4: A cross-sectional view of a second preferred embodiment of an inventive motion absorber, which is designed as a stroke absorber;

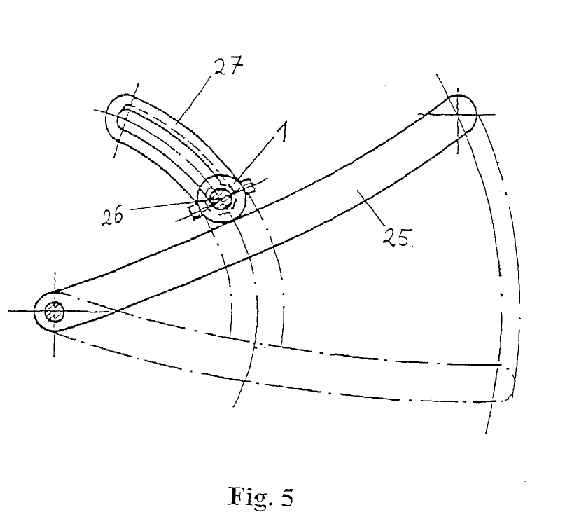

Figure 5: A side view of a part with an inventive motion absorber, the movement of which part is to be absorbed.

FIG. 1 illustrates in cross section a first preferred embodiment of the inventive motion absorber. Same has a cylindrical housing 1 in which is arranged a connecting member 2 movably supported with respect to the housing 1. The connecting member 2 is connected at one end 5 to the part 25, for example, a door or a cupholder, the movement of which part is to be absorbed. The connection to the part 25, the movement of which is to be absorbed, serves to transfer the absorbing motion from the connecting member 2, the movement of which is absorbed in the housing 1, to the movable part 25.

The motion absorber of FIG. 1 is designed as a rotation absorber. The rod-shaped connecting member 5 is for this purpose rotatably supported in the housing 1. The end 5 of the connecting member 2, which end is the upper end in the figure, extends out of the housing 1 through an opening 6 in a wall of the housing. A permanent magnet 3 is arranged inside of the housing on a housing face which lies opposite the opening 6. The permanent magnet 3 is designed disk-shaped and is glued or screwed to the inside surface of a housing lid 11. The permanent magnet 3 is thereby arranged in such a manner that its pole direction extends parallel to the axis of rotation 12 of the connecting member 2. The north pole of the permanent magnet 3 can face the housing lid 11 or can face away from the housing lid 11. A disk-shaped metal plate 4 made out of a magnetizable material is rigidly connected to and at the end of the connecting member 2, namely, the lower end in the figure. For the rigid fastening of the metal plate 4 to the connecting member 2, a center bore is provided in the metal plate 4 and into which is inserted the lower end of the connecting member 2. The metal plate 4 is fastened to the connecting member 2 by clamping, gluing, screwing or similar means.

A collar 13 extends axially from the underside of the metal plate 4 around the outside thereof. The collar 13 encloses the upper part of the disk-shaped permanent magnet 3. The flat underside 14 of the metal plate 4 is spaced from and opposes the upper side 15 of the magnet 3. A space is created between the upper side 15 of the permanent magnet 3 and the underside 14 of the metal plate 4. Also a space is created between the radial outer side of the magnet 3 and the inner side of the collar 13. In order to maintain a defined distance between the underside 14 of the metal plate 4 and the upper side 15 of the permanent magnet 3, it is possible to advantageously provide a spacer between magnet 3 and metal plate 4. All parts of the motion absorber, with the exception of the metal plate 4 and of the permanent magnet, are advantageously made out of plastic.

When the connecting member 2 is rotated, the metal plate 4, which is rigidly arranged on the connecting member 2, rotates also with respect to the housing 1. The metal plate 4 is thereby rotated in the static magnetic field of the permanent magnet 3. Eddy currents are thus created in the metal plate 4. These eddy currents act against the rotary motion of the metal plate 4 and therefore apply a braking force onto the metal plate 4. In order to produce a braking force onto the metal plate 4, same must be made out of a magnetizable material, preferably a ferromagnetic material.

The strength of the thus produced braking force depends essentially on the size of the space between the magnet 3 and the metal plate 4. In this manner, it is possible to adjust the braking force, for example, through an exact adjustment of the distance between the underside 14 of the metal plate 4 and the upper side 15 of the permanent magnet 3 to a desired value.

The magnetic braking force onto the metal plate 4 is transferred to the movable part 25 through the connecting member 2. The movement of the movable part 25 is in this manner absorbed.

FIG. 5 illustrates as an example a glove-compartment door 25 which is connected to an inventive motion absorber. To connect the motion absorber to the door 25, the connecting member 2 has a gear 26 at its end 5 which extends outwardly from the housing. The motion absorber is stationarily installed in the glove compartment. A circular segment-like curved rack 27 is mounted on the glove-compartment door 25. The rack 27 and the motion absorber are arranged in such a manner to one another that the gear 26 mates with the rack 27. The movement of the glove-compartment door 25 is transferred as a rotary motion onto the connecting member 2 in the housing 1 of the motion absorber through the mating of the rack 27 with the gear 26. Since the rotary motion of the connecting member 2 in the housing 1 of the motion absorber is absorbed by the magnetic force, also the movement of the glove-compartment door 25 is absorbed.

FIG. 2 illustrates a preferred embodiment of the rotation absorber of FIG. 1. The arrangement of the connecting member 2 in the housing corresponds essentially with the embodiment of FIG. 1. the same parts have therefore identical reference numerals.

A disk-shaped permanent magnet 3 is rigidly connected at the end of the connecting member 2 at the lower end thereof in the figure. A center bore is for this purpose provided in the permanent magnet 3, into which bore is received the lower end of the connecting member 2. The rigid connection of the connecting member 2 in the bore of the permanent magnet 3 is created by clamping, gluing or screwing.

The housing 1 is closed off at the front side opposite the opening 6 by a disk-shaped metal plate 4. The underside 16 of the permanent magnet 3 is thereby arranged at a distance from and opposes the upper side 17 of the metal plate 4. Between the underside 16 of the permanent magnet 3 and the upper side 17 of the metal plate 4 there is an air gap. Again a spacer can be provided for the precise adjustment of the distance.

When the connecting member 2 rotates with respect to the housing 1, the permanent magnet 3 inside of the housing is also rotated. Eddy currents are created in the metal plate 4 by the rotary motion of the magnet 3. These eddy currents act against their cause, namely the rotation of the magnet 3. The rotary motion of the magnet 3 with respect to the housing 1 is in this manner stopped. This braking force onto the magnet 3 is transferred through the connecting member 2 onto the movable part 25. The movement of the movable part 25 is in this manner absorbed.

FIG. 3 illustrates a preferred embodiment of the inventive motion absorber, which is also designed as a rotation absorber and is operated depending on the direction of rotation in a strongly absorbing load stroke (FIG. 3a) or a weakly absorbing idle stroke (FIG. 3b).

The rotation absorber of FIG. 3 includes a cylindrical housing which is closed off at the front side by a housing lid 11. The housing lid 11 is clamped to the housing by locking elements, which include a bar 33 and a detent 34. The connecting member 2 is rotatably supported in the housing 1. A gear 26 is arranged at the end 5 of the connecting member 2 that extends outwardly from the housing. The connecting member 2 can be connected through the gear 26 to the part 25, the movement of which is to be absorbed, as this is, for example, illustrated in FIG. 5.

A metal plate 4 is arranged inside of the housing 1 at the front side which is closed off by the housing lid 11. The metal plate 4 is rigidly connected to the housing 1 and/or the housing lid 11 by suitable means. A receiving housing 28 is arranged at the end of the connecting member 2, which end is the lower end in the figure. The receiving housing 28 consists of a hollow tubular shaft 29 and a cylindrical cup 30. A disk-shaped permanent magnet 3 is arranged in the cup 30. The permanent magnet 3 is thereby rigidly connected to the cup 30 by gluing, clamping or screwing. The end of the connecting member 2, which end is the lower end in the figure, extends into the shaft 29. The inside diameter of the shaft 29 is adapted to the diameter of the lower end of the connecting member in such a manner that the connecting member remains movable in the shaft 29. The shaft 29 has a slotted hole 31 extending inclined with respect to the axis of the connecting member. A guide pin 32 is mounted on the outside of the connecting member 2. The guide pin 32 is received in the slotted hole 31.

The receiving housing 28 with the shaft 29 is movable axially and radially with respect to the connecting member between an upper boundary position and a lower boundary position. FIG. 3a illustrates the receiving housing 28 in its lower boundary position. The receiving housing 28 and the permanent magnet 3 in the cup 30 of the receiving housing 28 rest in this position on the metal plate 4. When the connecting member 2 is rotated in clockwise direction to the position illustrated in FIG. 3a (in viewing direction of the end 5 extending outwardly of the housing), the receiving housing 28 with the permanent magnet 3 lifts away from the metal plate 4 since the engagement of the guide pin 32 in the slotted hole 31 pulls the receiving housing 28 upwardly. Thus by rotating the connecting member 2 in clockwise direction, the receiving housing 28 is moved into its upper boundary position illustrated in FIG. 3b. Whereas when the connecting member 2 is rotated counterclockwise to the position according to FIG. 3b, then the engagement of the guide pin 32 in the slotted hole 31 assures that the receiving housing 28 is pushed again into its lower boundary position according to FIG. 3a.

The permanent magnet 3 is in the upper boundary position of the receiving housing 28 arranged at a distance from the metal plate 4, whereas in the lower boundary position it rests on the plate or at any rate is spaced only at a small distance from the metal plate 4. Based on the large distance between the metal plate 4 and the permanent magnet 3 in the upper boundary position, the magnetic braking force is much reduced in this position. Thus the motion absorber is in an idle-stroke position (FIG. 3b).

A strong braking force is active between the metal plate 4 and the permanent magnet 3 in the lower boundary position, in which the permanent magnet 3 rests on the metal plate 4, so that the motion absorber works in this position during a working stroke with a strong absorption.

The rotation absorber of FIG. 3 operates as follows: The connecting member 2 is during opening of the movable door 25 rotated counterclockwise (in viewing direction of the end 5 protruding from the housing, thus in FIG. 5 movement in the plane of the paper). The receiving housing 28 is thus first of all, as described above, moved into its lower boundary position whereat the motion absorber works during a load stroke. The further movement of the door 25 is transferred onto the connecting member 2 as a rotary motion in the housing 1. Since the motion absorber is in the load stroke, this rotary motion of the connecting member 2 in the housing 1 is strongly absorbed by the magnetic force between the metal plate 4 and the permanent magnet 3 resting on the plate.

When opening the door 25, the movement of the door 25 is transferred into a rotary motion of the connecting member 2 in clockwise direction. The motion absorber is thereby first of all moved in the above-described manner into the idle stroke. The receiving housing 28 and the permanent magnet 3 fastened therein are in the idle stroke position arranged at a distance from the metal plate 4. Thus the magnetic braking force is significantly reduced due to the enlarged distance between the metal plate 4 and the permanent magnet 3. An easier movement of the door into the closing position without any or under at least a significantly reduced action of a braking force being made possible in this manner.

The arrangement of the metal plate 4 and the permanent magnet 3 can be interchanged in the exemplary embodiment illustrated in FIG. 3. Also it is possible to interchange the arrangement of the slotted hole 31 on the shaft 29 and the guide pin 31 on the connecting member 2 so that instead the slotted hole 31 is constructed as a recess on the outer surface of the connecting member 2 and the guide pin 32 is mounted on the inner surface of the shaft 29. Of importance is merely that the receiving housing 28 can be moved with respect to the connecting member 2 axially between an upper boundary position and a lower boundary position. The movement from one boundary position into the other is done thereby by rotating the connecting member 2 with respect to the housing 1.

FIG. 4 illustrates a further preferred embodiment of the inventive motion absorber, which is designed as a stroke absorber.

The stroke absorber of FIG. 4 has a cylindrical housing 1 and a piston 9 axially movably in the housing. A connecting member 2 designed as a piston rod is arranged on the piston 9. The upper end 5 of the piston rod 2, which end is the upper end in the figure, protrudes outwardly from the housing 1 through an opening 6. The end 5 of the connecting member 2, which end protrudes from the housing, is rigidly connected to or through a traction cable connected to the movable part (not illustrated here).

A disk-shaped permanent magnet 3 is arranged on the upper side 18 of the piston 9. The permanent magnet 3 has a center bore 19 through which extends the piston rod 2. The pole axis of the magnet 3 extends in the embodiment illustrated in FIG. 3 parallel to the axis 12 of the piston rod 2, whereby the south pole S is directed toward the upper side 18 of the piston 9.

A further disk-shaped permanent magnet 10 is arranged inside of the housing 1 on the face 22 through which extends the opening 6. The permanent magnet 10 has a center bore 20 through which the piston rod 2 extends. The permanent magnet 10 is thereby aligned such that its pole axis extends parallel to the axis 12 of the piston rod 2, and its north pole N lies opposing the north pole N of the permanent magnet 3.

The stroke absorber of FIG. 3 is in the base position of the movable part 25, for example when the door is closed, also in the base position when the piston 9 rests on the lower face 21 of the housing 1. When the door is opened, the piston rod 2 moves in axial direction out of the housing 1. The piston 9 is in this manner moved in a direction toward the upper face 22. The stroke motion of the piston 9 is stopped by the repelling magnetic forces of the permanent magnets 3 and 10. The braking force becomes thereby stronger the closer the piston 9 moves in direction toward the upper face 22. The braking force onto the piston 9 is transferred through the piston rod 2 onto the movable part 25. The movement of the part 25 to be moved is in this manner absorbed. The absorption increases thereby with an increasing opening of the door.

The upper side 23 of the magnet 3 rests on the underside 24 of the magnet 10 when the door is completely open. In order for the door to not again automatically close due to the repelling forces between the magnets 3 and 10, a locking mechanism is advantageously provided on the piston 9, through which locking mechanism the door can be locked in the open position.

As soon as the door is again moved in closing direction, the locking mechanism opens and again sets free the piston 9. Same is thereafter axially moved into the cylinder-shaped housing 1. This moving-in motion is assisted by the repelling forces of the magnets 3 and 10. An easier closing movement of the door is in this manner guaranteed.

The inventive motion absorber has compared to the conventional motion absorbers the advantage that the absorption of the movement of the connecting member 2 in the housing 1 does not depend on the surrounding temperature. Furthermore, the braking force produced by the magnetic field of the permanent magnet or magnets 3, 10 depends only very little on the speed of the moved part 25, for example, the opening speed of a door. This has the effect that in particular at the start of the opening operation of the door a base absorption exists. Only a very small absorbing action exists in the case of the conventional motion absorbers because of the very low speed during the start of the opening movement.

A viscous liquid, for example silicone oil or a liquid polymer, is placed inside of the housing in a particularly preferred exemplary embodiment of the inventive motion absorber. The liquid is distributed inside of the housing 1 and moves in particular in the case of a rotation absorber according to FIGS. 1 and 2 into the space between the metal plate 4 and the permanent magnet 3.

The movement of the connecting member 2 is absorbed in addition to the magnetic braking force through frictional force through the inner friction in the provided liquid. This absorption through frictional forces depends, as this is the case in conventional viscous absorbers, strongly on the speed of the movable part 25, for example a door. In combination with the magnetic braking force of the inventive absorber this preferred embodiment has thus a basic absorption almost completely independent from the speed of the door, and an additional absorption depending strongly on the speed. This has the result that during the entire opening operation of the door there exists an absorbing action. During the start of the opening operation, during which the door moves at a very low speed, there exists a comparatively low basic adsorption caused by the magnetic force. During the course of the opening operation of the door, its speed increases, thus increasing the fluidy absorption. Opening speeds of the door, which speeds are too high, are avoided in this manner.

1. A motion absorber comprising a housing (1), a connecting member (2) movably supported with respect to the housing, which connecting member can be connected to a movable part (25), the movement of which is to be absorbed, and comprising an absorber element, which absorbs the movement of the connecting member (2), wherein the absorber element is divided in two and includes a permanent magnet (3) and an opposite pole (4), and the magnetic force between the permanent magnet (3) and the opposite pole (4) absorbs the movement of the connecting member (3) in the housing (1).

2. The motion absorber according to claim 1, wherein the permanent magnet is arranged on the connecting member, and the opposite pole (4) is arranged inside of the housing spaced from the permanent magnet (3), and is formed by a further permanent magnet or by a plate made of a magnetizable material.

3. The motion absorber according to one of the claims 1 or 2, wherein the connecting member (2) is designed as a shaft and is supported rotatably in the housing (1), and the one end (5) of the connecting member (2) extends outwardly from the housing through an opening (6).

4. The motion absorber according to claim 3, wherein the absorber element is formed by a permanent magnet (3) arranged at the other end of the connecting member (2), and a metal plate (4) arranged inside of the housing (1) on a front side opposite the opening (6) and at a distance from the permanent magnet (3).

5. The motion absorber according to claim 3, wherein the absorber element is formed by a metal plate (4) arranged at the other end of the connecting member (2), and a permanent magnet (3) arranged inside of the housing on the face opposite the opening (6) and at a distance from the metal plate (4).

6. The motion absorber according to one of the claims 1 to 5, wherein the distance between the permanent magnet (3) and the opposite pole (4) can be changed between an upper and a lower boundary position by rotating the connecting member (2) with respect to the housing (1), whereby the upper boundary position distance is adjusted upon rotation of the connecting member (2) in one direction, and the lower boundary position distance upon rotation of the connecting member in the opposite direction.

7. The motion absorber according to claim 6, wherein the opposite pole (4) is arranged on an inside face of the housing and is rigidly connected to same, and the permanent magnet (3) is arranged axially movably with respect to the connecting member (2) at the other end of the connecting member (2) between an upper boundary position and a lower boundary position, whereby the permanent magnet (3) moves upon rotation of the connecting member (2) in one direction into its upper boundary position, and upon rotation of the connecting member (2) in the opposite direction into its lower boundary position.

8. The motion absorber according to claim 6, wherein the permanent magnet (3) is arranged on an inside face of the housing (1) and is rigidly connected to same, and the opposite pole (4) is arranged axially movably with respect to the connecting member (2) at the other end of the connecting member (2) between an upper boundary position and a lower boundary position, whereby the opposite pole (4) moves upon rotation of the connecting member (2) in one direction into its upper boundary position, and upon rotation of the connecting member (2) in the opposite direction into its lower boundary position.

9. The motion absorber according to claim 1, wherein the connecting member (2) is designed as a piston rod and is axially movable with respect to the housing (1), a piston (9) is arranged at one end of the connecting member (2), which piston carries at least one first permanent magnet (3) and a second permanent magnet (10) is fastened inside of the housing (1), whereby the axial movement of the connecting member (2) inside of the housing (1) is absorbed by the reciprocal force of the permanent magnets (3, 10).

10. The motion absorber according to claim 9, wherein the other end (5) of the connecting member (2) extending outwardly from the housing (1) through an opening (6), the second permanent magnet (10) is arranged on the face having the opening (6), whereby the magnets (3, 10) are aligned such that like poles are opposite one another.

11. The motion absorber according to claim 9, wherein the other end (5) of the connecting member (2) extending outwardly from the housing (1) through an opening (6), the second permanent magnet (10) is arranged on the face opposite the opening (6), whereby the magnets (3, 10) are aligned so that opposite poles oppose one another.

12. The motion absorber according to one of the preceding claims, wherein a viscous liquid (8) is present at least in the area between the permanent magnet (3) and the opposite pole (4), which liquid absorbs speed-dependently the movement of the connecting member (2) in addition to the magnetic braking force.
